(19) United States
(12) Patent Application Publication
(10) Pub. No.: US 2017/0083896 A1
(43) Pub. Date: Mar. 23, 2017

(54) APPLICATION BASED PERSONALIZED RETAILING

(71) Applicant: MasterCard International Incorporated, Purchase, NY (US)

(72) Inventor: Ankur Arora, New Delhi (IN)

(21) Appl. No.: 15/266,601

(22) Filed: Sep. 15, 2016

(30) Foreign Application Priority Data
Sep. 18, 2015 (SG) 10201507793Q

(51) Int. Cl. G06Q 20/32; H04W 12/06; G06K 7/10; G06Q 20/10; H04W 4/00; G06Q 30/02; H04W 4/02

(52) U.S. Cl. CPC G06Q 20/3221; G06Q 30/0207; H04W 12/06; H04W 4/021; G06Q 20/102; H04W 4/008; G06K 7/10009

(57) ABSTRACT

A method and system for a merchant to provide a personalized shopping experience for a customer having an active mobile device while shopping is provided. The method includes providing a signal for generating a personalized welcome message on the active mobile device when the customer enters a defined shopping area of the merchant and providing identification of the customer and a location of the customer within the defined shopping area to sales personnel of the merchant so that the sales personnel can personally greet the customer. The method also includes providing at least one of personalized messages, customized coupons, and shopping recommendations to the active mobile device for presentation thereon in response to the merchant receiving an index of at least one of the customer's average spend and spend history.

### CROSS REFERENCE TO RELATED APPLICATIONS

This application claims the benefit of Singapore Patent Application No. 10201507793Q filed Sep. 18, 2015, which is hereby incorporated by reference in its entirety.

### BACKGROUND

The present disclosure generally relates to methods and systems for communication and retail sales, and more particularly relates to methods and systems for personalizing a customer's shopping experience.

In times past, small shopkeepers knew their customers well and could readily attend to their wants and needs as they could easily recall or determine their past purchases in terms of average spend and kind of categories shopped. However, with the advent of retail chains with multiple outlets and multiple categories of goods, personalized selling has disappeared leading to significant loss in revenues for the retailers.

Thus, what is needed is a system and method for providing personalized selling to customers shopping at large retail chains with multiple categories which at least partially overcomes the present drawbacks. Furthermore, other desirable features and characteristics will become apparent from the subsequent detailed description and the appended claims, taken in conjunction with the accompanying drawings and this background of the disclosure.

### BRIEF DESCRIPTION

According to at least one embodiment of the present disclosure a method for a merchant to provide a personalized shopping experience for a customer having an active mobile device while shopping is provided. The method includes providing a signal for generating a personalized welcome message on the active mobile device when the customer enters a defined shopping area of the merchant and providing identification of the customer and a location of the customer within the defined shopping area to sales personnel of the merchant so that the sales personnel can personally greet the customer. The method also includes providing at least one of personalized messages, customized coupons, and shopping recommendations to the active mobile device for presentation thereon in response to the merchant receiving an index of at least one of the customer's average spend and spend history.

In accordance with another aspect of at least one embodiment of the present disclosure, a system for a merchant to provide a personalized shopping experience for a customer having an active mobile device while shopping is provided. The system includes a processor, an entry detection system, a wireless transceiver, and a plurality of wireless sensors. The entry detection system is coupled to the processor for defining a shopping area. The wireless transceiver is coupled to the processor and transmits a signal for generating a personalized welcome message on the active mobile device when the customer enters the defined shopping area. And the plurality of wireless sensors provide identification of the customer and a location of the customer within the defined shopping area to sales persons associated with the merchant in response to detecting a location of the customer within the defined shopping area proximate to the sales persons so that the sales persons can personally greet the customer. The wireless transceiver also provides at least one of personalized messages, customized coupons, and shopping recommendations to the active mobile device for presentation thereon in response to the merchant receiving an index of at least one of the customer's average spend and spend history.

In accordance with yet another aspect of at least one embodiment of the present disclosure, a portable communication device is provided. The portable communication device includes a processor, a plurality of wireless transceivers, a user interface and a memory. The plurality of wireless transceivers are coupled to the processor and a first one of the plurality of transceivers communicates with a payment gateway and a second one provides low power wireless communication. The user interface is coupled to the processor and includes a user input device for receiving user inputs and a user output device for presenting information to a user including at least one of personalized messages, customized coupons, and shopping recommendations. And the memory is coupled to the processor and stores application software which when loaded to the processor and authenticated by a user input wirelessly retrieves payment card spend history from a payment gateway and stores the payment card spend history in the memory.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with a present disclosure, by way of non-limiting example only, wherein:

FIG. 1 illustrates a block diagram of a system including a payment gateway and a portable wireless communication device in accordance with a present embodiment;

FIG. 2 illustrates a diagram of a system in accordance with the present embodiment for a merchant to provide a personalized shopping experience for a customer having the portable wireless communication device of FIG. 1 while shopping;

FIG. 3 illustrates a RFID tagged good offered for sale in the geofenced shopping area of FIG. 2 in accordance with the present embodiment; and

FIG. 4 illustrates a flow diagram of operation of the system of FIG. 2 in accordance with the present embodiment.

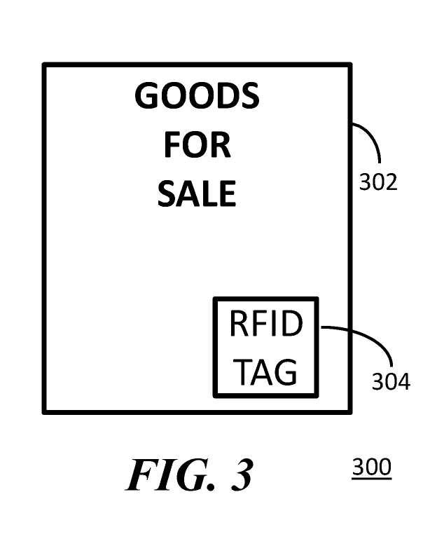

Skilled artisans will appreciate that elements in the figures are illustrated for simplicity and clarity and have not necessarily been depicted to scale. For example, the size of some parts of the diagram of FIG. 3 may not be accurate in respect to other parts of the diagram but are shown in such a manner as to improve understanding of the system and method in accordance with the present embodiment.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is the intent of this disclosure to present a system and method for providing personalized selling by large retail chains selling multiple categories of goods.

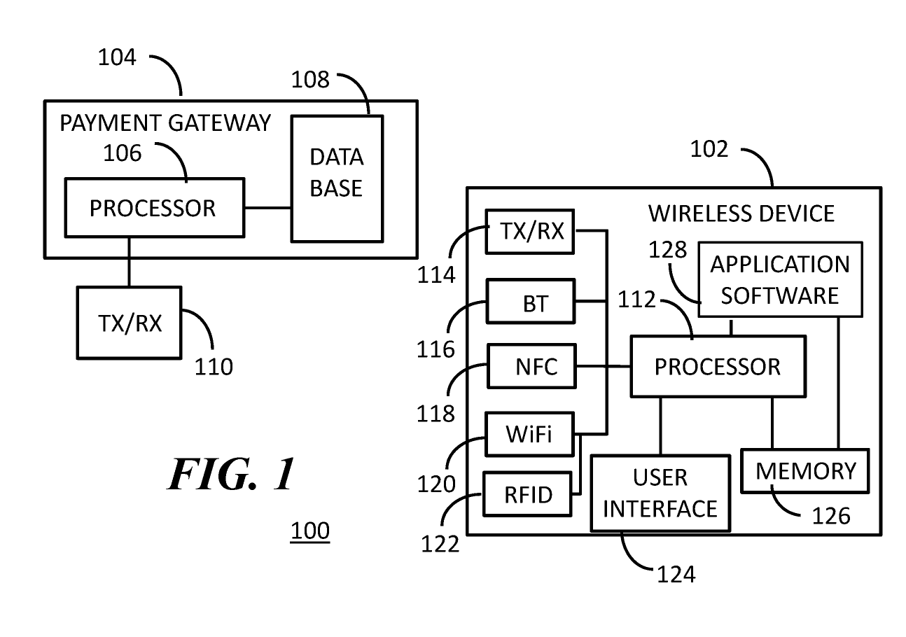

Referring to FIG. 1, a diagram 100 depicts a customer wireless device 102 and a payment gateway 104. The payment gateway includes at least a processor 106 and a database 108, the processor 106 coupled to the database 108 and to a transceiver 110. As the payment gateway 104 is accessed for all purchases by the customer on one or more credit/debit cards (also known as payment cards), the database 108 has a plurality of historic transactions detailing the customer's spend history which can be divided into various categories such as clothing, footwear, sports and restaurants and the categories can be further divided into subcategories such as fine dining restaurants and fast food restaurants.

The customer's wireless device 102 is a portable communication device such as a smartphone, which includes a processor 112, a plurality of wireless transceivers such as a cellular transceiver 114, a Bluetooth (BT) transceiver 116, a near field communication (NFC) transceiver 118, a WiFi transceiver 120, and a radio frequency identification (RFID) tag reader 122, whereas it may be advantageous to combine some of the transceivers, e.g. NFC and RFID, into one physical interface.

The wireless device 102 also includes a user interface 124 and a memory 126, both coupled to the processor 112. The user interface 124 includes a user input device for receiving user inputs and a user output device for presenting information to the customer including at least one of personalized messages, customized coupons, and shopping recommendations transmitted to the customer's wireless device in accordance with the present embodiment.

The wireless device 102 can couple to the payment gateway 104 via cellular communication via the cellular transceiver 114 and the transceiver 110. Alternatively, the wireless device 120 could couple to the payment gateway via the Internet using the WiFi transceiver 120 and the payment gateway's connection to the Internet.

The memory 126 stores application software 128 which when loaded to the processor 112 and authenticated by a user input received at the user interface 124 wirelessly retrieves the credit/debit card spend history from the payment gateway 104 and stores the credit/debit card spend history in the memory 126. In this manner, the customer can activate the application software 128 for personalized shopping in accordance with the present embodiment.

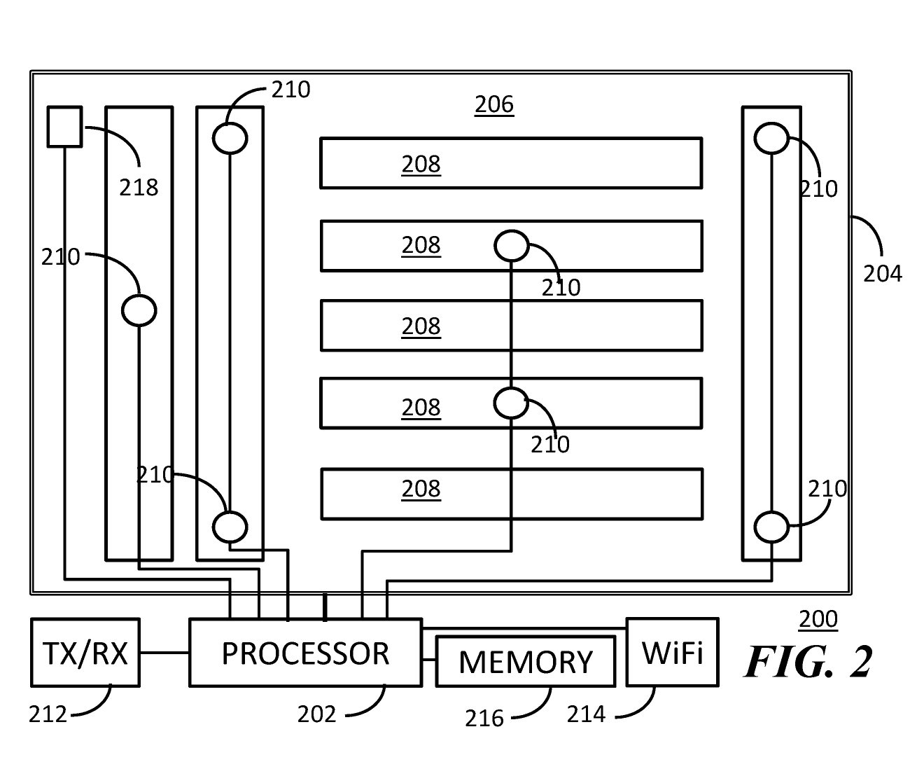

A system 200 for a merchant to provide a personalized shopping experience for a customer having an active mobile device while shopping such as the mobile device 102 is depicted in FIG. 2. The system includes a processor 202 coupled to a wireless geofencing system 204 for wirelessly geofencing a shopping area 206. While the exemplary shopping area 206 in FIG. 2 is defined by geofencing, those skilled in the art will realize that other methods could be used for defining the shopping area in a manner so that the active mobile device can detect when it enters and leaves the defined shopping area 206. The shopping area 206 includes areas for selling multiple categories of goods such as aisles 208. A plurality of wireless sensors 210 are distributed around the shopping area 206 for locating customers within the shopping area 206. The wireless sensors 210 can be Bluetooth low energy (BLE) transceivers or wireless beacons such as iBeacon wireless sensors.

The processor 202 is also coupled to a wireless transceiver 212 and a WiFi transceiver 214 for communicating with a customer's wireless device 102. The WiFi transceiver 214 provides WiFi signals within the geofenced shopping area 206 to ping off the customer's active mobile device 102 for identifying the customer by a media access control (MAC) address in the WiFi communication received from the mobile device 102 in response to the pinging thereof. In this manner, the location and identification of the customer within the geofenced shopping area 206 can be determined by the processor 202 from the WiFi transceiver 214 and the plurality of wireless sensors 210.

The memory 216 is also coupled to the processor for storing an index of at least one of the customer's average spend and the customer's spend history after the customer has authorized the download of this information from this mobile device 102 by authenticating the merchant via a NFC tag or by NFC signaling when holding the mobile device in proximity to a merchant terminal 218.

Referring to FIG. 3, the diagram 300 depicts a further enhancing of the customer's shopping experience with the merchant. Goods 302 offered for sale by the merchant each have a RFID tag affixed thereto or co-located therewith. The customer can scan the RFID tag 304 of the goods 302 for immediate application of discounts, cashbacks or other value added services.

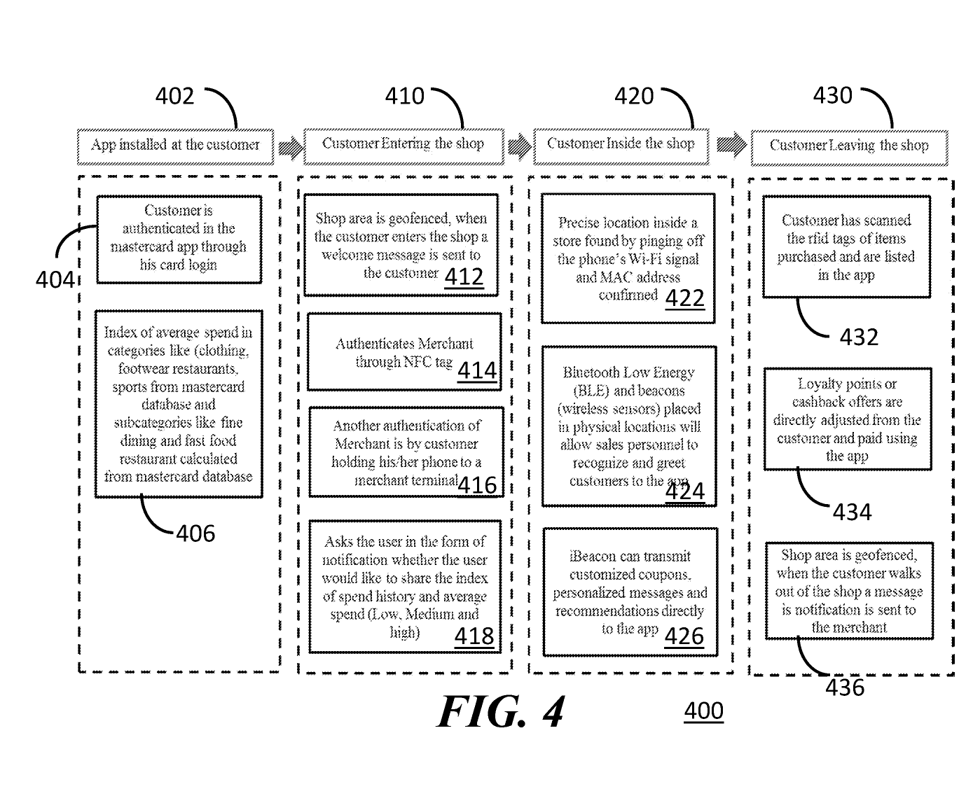

Referring to FIG. 4, a diagram 400 depicts operation of the system 200 in accordance with the present embodiment. Initially, the customer installs 402 the application software 128 on his mobile device 102. The customer is authenticated 404 by the application software 218 through a credit/debit card login. This login is done once when installing the application software 218 and allows the mobile device 102 to retrieve 406 credit/debit card details (e.g., historic transaction details) from the payment gateway 104. When the customer retrieves 406 the credit/debit card details, his index of average spend in various categories (e.g., clothing, footwear, restaurants, sports) are calculated and stored in the memory 126 of the wireless device 102. All of the categories can be further broken into sub categories based on average spend in the industry. For example, the restaurant category can be broken into fast food and fine dining based on average ticket size spent in a single transaction. To further differentiate between various customer spend activates, the average ticket sizes are categorized as high, medium and low end in each of the various categories. All of this information is stored in the memory 126 so that the application software 128 has a plurality of flags for customer spend activity across the various categories with flags set as low, medium and high spender in each of the various categories. In accordance with the present embodiment, the customer with the application software 128 installed on his mobile device 102 and the various average spend flags set as well as the index of average spend stored in the memory 126 then visits a large retailer.

As seen in FIG. 2, the shop area 206 is geofenced by the geofencing system 204. When the customer enters 410 the shopping area 206, the geofencing system 204 detects the customer. The merchant via the processor 202 provides a signal to the mobile device 102 for generating a personalized welcome message on the user output device of the user interface 124. For example, the merchant could send a message welcoming the customer such as “Good Morning! We are happy to have you in our store!” The application software 128 authenticates 414, 416 the customer with the merchant system 200 to determine whether his personalized information can be shared with the merchant by either the customer holding his/her mobile device 102 to the merchant terminal 218 or through an NFC tag. If the authentication is successful, the customer immediately receives 418 personalized messages, customized coupons and shopping recommendations tailor-made according to the index of at least one of the customer's average spend and the customer's spend history, the received information presented on the user output device of the user interface 124 of the mobile device 102.

When multiple customers are 420 inside the shopping area 206, the precise location and the identification of each customer can be determined 422 by pinging off the mobile device's Wi-Fi signal using the MAC address which is unique to each customer's mobile device. This tracking works even if the customer never connects to the merchant's Wi-Fi network 214. With the precise location known inside the shopping area 206, a combination of Bluetooth Low Energy (BLE) and beacons (wireless sensors) placed in physical locations 210 allow sales personnel of the merchant to recognize and personally greet customers 424, as well as provide them with individualized attention based on their previous transaction history. Also, the iBeacon 210 can transmit 426 customized coupons, personalized messages and recommendations directly to the application software 128 based on at least one of the customer's current location in the shopping area 206 and a past purchase history of the customer with the merchant as well as the other merchants based on the personalized information shared with the merchant including the index of the customer's average spend and the customer's spend history.

Before the customer leaves 430 the merchant's shopping area 206, he can scan 432 the RFID tags 304 of items 302 he wishes to purchase. The application software 128 shares a flag indication as high, medium or low spender in different categories with the merchant point-of-sale (POS) machine, such as the terminal 218, which can directly check out the customer. Any loyalty points or cashback offers are directly adjusted 434 from the customer and paid using the application software. The customer walks out of the merchant's shopping area 206 having successfully shopped as per his preference without waiting in line at any point. Since the area is geofenced by the geofencing system 204, the merchant immediately receives 436 notification that the customer has exited the shopping area 206.

Thus, it can be seen that the present embodiment can advantageously and automatically provide a personalized experience for the customer as he moves through a retail store. In addition, operation in accordance with the present embodiment, allows the merchant to provide customized offerings and attention using the personalized customer profiles thereby resulting in an increased chance of successful sales. While exemplary embodiments have been presented in the foregoing detailed description of the disclosure, it should be appreciated that a vast number of variations exist.

It should further be appreciated that the exemplary embodiments are only examples, and are not intended to limit the scope, applicability, operation, or configuration of the disclosure in any way. Rather, the foregoing detailed description will provide those skilled in the art with a convenient road map for implementing an exemplary embodiment of the disclosure, it being understood that various changes may be made in the function and arrangement of elements and method of operation described in an exemplary embodiment without departing from the scope of the disclosure as set forth in the appended claims.

1. A method for a merchant to provide a personalized shopping experience for a customer having an active mobile device while shopping, the method comprising:
providing a signal for generating a personalized welcome message on the active mobile device when the customer enters a defined shopping area of the merchant;
providing identification of the customer and a location of the customer within the defined shopping area to sales personnel of the merchant so that the sales personnel can personally greet the customer; and
providing at least one of personalized messages, customized coupons, and shopping recommendations to the active mobile device for presentation thereon in response to the merchant receiving an index of at least one of the customer's average spend and spend history.

2. The method in accordance with claim 1, wherein the step of providing personalized messages, customized coupons, and shopping recommendations only occurs after permission is granted to the merchant to access information stored on the active mobile device.

3. The method in accordance with claim 2, wherein the customer grants permission to the merchant by the customer authenticating the active mobile device within the defined shopping area.

4. The method in accordance with claim 3, wherein the customer authenticates the active mobile device by near field communication (NFC) tagging within the defined shopping area or NFC communication with a merchant terminal within the defined shopping area.

5. The method in accordance with claim 1, wherein the step of providing personalized messages, customized coupons and shopping recommendations further comprises generating at least one of the personalized messages, the customized coupons, and the shopping recommendations in response to a customer spend history generated from a payment card spend history stored on the active mobile device.

6. The method in accordance with claim 5, wherein the step of generating at least one of the personalized messages, the customized coupons, and the shopping recommendations further comprises calculating an index of the customer's average spend in response to the customer spend history.

7. The method in accordance with claim 5, wherein the credit/debit payment card spend history stored on the active mobile device is retrieved by the active mobile device wirelessly coupled to a payment gateway maintaining the payment card spend history.

8. The method in accordance with claim 1 further comprising inputting identification information of items to be purchased into the active mobile device while shopping in the defined shopping area.

9. The method in accordance with claim 8, wherein discounts from at least one of coupons value added programs are accessed by the active mobile device and directly adjusted while inputting identification information of items to be purchased into the active mobile device.

10. The method in accordance with claim 9, wherein the value added programs include programs providing loyalty points.

11. The method in accordance with claim 1 further comprising notifying the merchant when the customer departs from the defined shopping area.

12. The method in accordance with claim 1, wherein the defined shopping area is defined by geofencing the defined shopping area to create a geofenced shopping area, and wherein the step of providing the signal for generating the personalized welcome message further comprises providing the signal for generating the personalized welcome message on the active mobile device when the customer enters the geofenced shopping area of the merchant.

13. A system for a merchant to provide a personalized shopping experience for a customer having an active mobile device while shopping, the system comprising:
a processor;
an entry detection system coupled to the processor for defining a shopping area;
a wireless transceiver coupled to the processor and transmitting a signal for generating a personalized welcome message on the active mobile device when the customer enters the defined shopping area; and
a plurality of wireless sensors for providing identification of the customer and a location of the customer within the defined shopping area to sales persons associated with the merchant in response to detecting a location of the customer within the defined shopping area proximate to the sales persons so that the sales persons can personally greet the customer,
wherein the wireless transceiver further provides at least one of personalized messages, customized coupons, and shopping recommendations to the active mobile device for presentation thereon in response to the merchant receiving an index of at least one of the customer's average spend and spend history.

14. The system in accordance with claim 13 further comprising a WiFi transceiver coupled to the processor and operating within the defined shopping area to ping off the active mobile device for locating the customer within the defined shopping area and identifying the customer by the media access control (MAC) address received from the active mobile device in response to the pinging of the active mobile device and the location and identification of the customer provided to the sales persons so that the sales persons proximate to the customer can personally greet the customer.

15. The system in accordance with claim 13, wherein the plurality of wireless sensors comprise at least one of low power wireless transceivers and iBeacon wireless sensors.

16. The system in accordance with claim 15, wherein the low power wireless transceivers comprise Bluetooth Low Energy (BLE) transceivers.

17. The system in accordance with claim 13 further comprising a plurality of RFID tagged goods within the defined shopping area enabling the customer to input identification information of items to be purchased into the active mobile device by scanning RFID tags of the RFID tagged goods.

18. The system in accordance with claim 13, wherein the entry detection system comprises a geofencing system for geofencing the defined shopping area.

19. A portable communication device comprising:
a processor;
a plurality of wireless transceivers coupled to the processor, a first one of the plurality of transceivers for communicating with a payment gateway and a second one for low power wireless communication;
a user interface coupled to the processor and including a user input device for receiving user inputs and a user output device for presenting information to a user including at least one of personalized messages, customized coupons, and shopping recommendations; and
a memory coupled to the processor and storing application software which when loaded to the processor and authenticated by a user input wirelessly retrieves payment card spend history from a payment gateway and stores the payment card spend history in the memory.
